(19) United States
(12) Patent Application Publication
(10) Pub. No.: US 2025/0043396 A1
(43) Pub. Date: Feb. 6, 2025

(54) CRACK-RESISTANT CO-NI-CR-W-LA ALLOY FOR POWDER-BASED ADDITIVE MANUFACTURING

(71) Applicant: OERLIKON METCO (US) INC., Westbury, NY (US)

(72) Inventors: Dongmyoung LEE, Novi, MI (US); Satya N. KUDAPA, Sterling Heights, MI (US)

(73) Assignee: OERLIKON METCO (US) INC., Westbury, NY (US)

(21) Appl. No.: 18/705,807

(22) PCT Filed: Nov. 4, 2022
(86) PCT No.: PCT/US2022/048955

§ 371 Date: Apr. 29, 2024

Related U.S. Application Data
(60) Provisional application No. 63/276,191, filed on Nov. 5, 2021.

(51) Int. Cl. C22C 30/00; B22F 1/052; B22F 10/28; B22F 10/366; B33Y 10/00; B33Y 70/00

(52) U.S. Cl. CPC C22C 30/00; B22F 1/052; B22F 10/28; B22F 10/366; B22F 2304/10; B33Y 10/00; B33Y 70/00

(57) ABSTRACT

An alloy for powder-based additive manufacturing is provided that includes a powder having 20-24 wt % of Ni; 20-24 wt % of Cr, 13-16 wt % of W; 0.2-0.50 wt % of Si; 0-3 wt % of Fe; 0-1.25 wt % of Mn; 0-0.015 B; >0 C; >0 La; and a balance of Co, in which a ratio in a content of C to La in the alloy is <1.75.

### CROSS-REFERENCE TO RELATED APPLICATION

This application claims the benefit under 35 U.S.C. § 119(e) of U.S. Provisional Application No. 63/276,191 filed Nov. 5, 2021, the disclosure of which is expressly incorporated by reference herein in its entirety.

### BACKGROUND

### 1. Field of the Invention

The present disclosure relates to producing three-dimensional metal articles by powder-based additive manufacturing, such as selective laser melting (SLM) also known as laser-based powder bed fusion (L-PBF), direct energy deposition (DED)/laser metal deposition (LMD), or electron beam melting (EBM) processes. In particular, the present disclosure relates to a Co—Ni—Cr—W—La alloy with a modified chemical composition compared to cast and/or wrought alloys of similar compositions for manufacturing crack-free or nearly crack-free components and articles by SLM/L-PBF, LMD/DED and EBM processes.

### 2. Discussion of Background Information

Due to the unique processing of metal additive manufacturing, also known as 3D printing, with SLM/L-PBF (e.g., rapid solidification from melt), conventional alloys are prone to cracking during 3D printing because these alloys have been originally developed for forging, rolling, or casting processes, not SLM/L-PBF processes.

Often when a material for additive manufacturing is required, a skilled artisan uses a known alloy that has been previously used in a rolled, forged, or other wrought forms, including a sheet, a plate, a bar, or casting. Frequently, the chemical composition of the wrought or cast alloy composition is copied over into the specification of a powdered material for additive manufacturing, as is the case for a conventional Co—Ni—Cr—W—La alloy. However, this can lead to macrocracking and/or microcracking problems with the additively built, laser welded metal articles.

A conventional alloy used in 3D printing is Haynes alloy 188. According to the manufacturer's information on the baseline wrought/cast for Haynes alloy 188, the alloy is classified as being readily weldable by Gas Tungsten Arc (GTAW), Gas Metal Arc (GMAW), Shielded Metal Arc (SMAW), electron beam welding, and resistance welding techniques. See Haynes International—HAYNES 188 alloy, www.haynesintl.com/docs/default-source/pdfs/new-alloy-brochures/high-temperature-alloys/brochures/188-brochure. Based upon the manufacturer's information, the basic alloy composition of Haynes alloy 188 is in the class of weldable materials. However, cracking was observed in the 3D printed material during SLM/L-PBF processing of this conventional alloy. Such cracking is generally accepted to be primarily caused by internal stresses built up in the three-dimensional metal part during the laser welding process, see Fraunhofer ILT, “Flying High with VCSEL Heating,” press release, Oct. 4, 2018.

The internal stresses are caused by temperature gradients in the generated component. In the laser spot, for example, temperatures above the melting point prevail, while the remaining regions of the component cool rapidly. Depending on the geometry and alloy, this temperature gradient can lead to cracks in the 3D printed material.

In the above-noted Fraunhofer press release, a conventional approach to solve the cracking problem in the Co—Ni—Cr—W—La alloys is described by heating the powder bed at high temperatures during the 3D printing process, either from the base plate of the build chamber of an SLM/L-PBF machine, or, more effectively, from the top of the build chamber of the machine by directly heating the layer that is actively being welded, which avoids or reduces the internal stresses in the article that ultimately leads to the cracking. Using the latter heating process, the temperature in the top layer can reach up to 900° C., which is high enough to avoid the cracking.

However, before a finished part can be removed from such a heated powder bed, it must be cooled to ambient temperature. Due to the low heat conductivity of powder beds, the heating and cooling of the powder bed requires a considerable amount of time resulting in a significant decrease in productivity of the SLM/L-PBF process. Furthermore, expensive heating equipment, insulation, and adaptation of the process chamber are necessary in this conventional process. Commercial SLM/L-PBF machines presently on the market are limited in their capability to provide heating of the powder bed at high temperatures.

Another approach to solve the cracking problem in Ni- and Co-based alloys during additive manufacturing is to apply a heat treatment at high external pressures and high temperatures to close and repair any remaining porosity and cracks formed in the 3D printed material. This is known as Hot Isostatic Pressing (HIP). HIP is effective for closed internal pores and cracks; however, it does not repair all surface cracking. Also, this HIP approach includes an additional processing step to the 3D printing of articles which adds to the manufacturing cost.

Hence, there is a need to provide a Co—Ni—Cr—W—La alloy similar to the wrought/cast material that is in powder form and can be processed in non- or only slightly heated powder beds that does not require post 3D printing processing steps to repair cracks by, for example, pressurized heat treatment, such as Hot Isostatic Pressing.

### SUMMARY

Embodiments provide a Co-base alloy with a high content of Ni, Cr, and W for powder-based additive manufacturing of three-dimensional articles with a significantly reduced tendency to form cracks in the microstructure during additive manufacturing in a powder bed and a process for manufacturing such an article. In embodiments of the present disclosure, the Co—Ni—Cr—W—La alloy composition comprises a powder having the following chemical composition:
20.0-24.0 wt % of Ni;
20.0-24.0 wt % of Cr;
13.0-16.0 wt % of W;
0.2-0.5 wt % of Si;
0-3 wt % of Fe;
>0-1.25 wt % of Mn;
0-0.015 wt % of B;
>0 wt % of C;
>0 wt % of La; and
a balance of Co and unavoidable residual elements and impurities.

In embodiments, the alloy composition is available as a wrought material with C (Carbon) content ranging from 0.05 to 0.15 wt % and La (Lanthanum) content ranging from 0.02 to 0.12 wt %. In other embodiments, the alloy composition is provided as a powder material. As a powder material, the alloy composition can be used in powder-based additive manufacturing, such as SLM/L-PBF, DED/LMD, or EBM, with a typical grain size distribution ranging from 10 to 100 μm, which infrequently leads to cracks formed in the articles by the processes.

In one embodiment of the present disclosure, the Carbon content is 0.05 to 0.15 wt. %. In a preferred embodiment of the present disclosure, the Carbon content is 0.05 to 0.10 wt. %. In another embodiment of the present disclosure, the Carbon content is 0.01 to 0.05 wt. %. In yet another embodiment of the present disclosure, the Carbon content is 0.01 to 0.04 wt. %. In another embodiment of the present disclosure, the Carbon content is 0.01 to 0.03 wt. %.

In example embodiments, the alloy composition includes a ratio of C/La that produces crack-free or near-crack-free articles by laser based powder bed additive manufacturing processes over a range of processing parameters without preheating and without HIP.

The inventors have found that the generally accepted content ranges for C and La in the wrought alloy composition of conventional Co—Ni—Cr—W—La alloys have a ratio of C/La that is unacceptably broad for powder-based additive manufacturing, if crack-free or nearly crack-free three-dimensional articles of complex shapes are intended to be provided on a consistent basis. For typical content ranges of C and La in the conventional Co—Ni—Cr—W—La alloys, the theoretical minimum ratio of C/La, (C/La)ₘᵢₙ is 0.42 and the theoretical maximum ratio is (C/La)ₘₐₓ is 7.50. The ratio at the nominal content ranges of C and La of a conventional Co—Ni—Cr—W—La alloy composition is (C/La)ₙₒᵣₘ=0.10/0.03=3.33.

In embodiments of the present disclosure, the content ratio of C/La in the Co—Ni—Cr—W—La alloy embodiments is 0.1 to 2, preferably, 0.1 to 1.5, and more preferably 0.1 to 1.

In an advantageous embodiment of the present disclosure, a Co—Ni—Cr—W—La alloy in powder form has a ratio of C/La<1.75 in order to achieve crack-free printing with a powder-based additive manufacturing process, such as SLM/L-PBF.

In example embodiments of the present disclosure, laser-based powder bed additive manufacturing processing parameters achieve dense structures that show a slight amount of porosity in the final structure, such as <0.10 vol %, which translates into >99.90% relative density of the metal article produced. In example embodiments, the laser volume density, E_{D}, is in the range of 50 to 150 J/mm³, preferably 75 to 100 J/mm³, and more preferably 80 to 90 J/mm³.

The laser volume energy density is calculated as follows:

$${E}_{D} = P / ( v . h . t )$$

in which P is the laser power in Watts, v is the laser surface scanning speed (in mm/s), h is the hatch spacing (in mm) and t is the layer thickness (in mm) of each of the welded powder layers formed during the powder-based additive manufacturing process.

In other embodiments of the present disclosure, the layer thickness of each welded powder layer in the additively manufactured metal component is in the range of 0.01-0.1 mm, and preferably in the range of 0.02-0.07 mm.

Embodiments are directed to an alloy powder for powder-based additive manufacturing that includes a powder. The powder includes 20-24 wt % of Ni; 20-24 wt % of Cr; 13-16 wt % of W; 0.2-0.50 wt % of Si; >0 wt % of Mn; >0 wt % of C; >0 wt % of La; and a balance of Co. A ratio in a content of C to La in the powder is 0.1 to 1.75.

According to embodiments, the C content can be 0.01 to 0.05 wt %.

In accordance with embodiments, the powder may have a particle size distribution of 10-120 μm.

In other embodiments, the powder has a spherical morphology and a particle size distribution of 10-50 μm and a D50 of 25-35 μm.

According to still other embodiments, the powder may further include >0-3 wt % of Fe; >0-1.25 wt % of Mn; and >0-0.015 wt % of B.

In still other embodiments, a method for additive manufacturing a 3-dimensional article can include subjecting the alloy powder according to claim 1 to a powder-based additive manufacturing process having a laser volume energy density calculated by: ED=P/v·h·t, where P is laser power, v is laser surface scanning speed, h is hatch spacing, and t is a layer thickness for each welded powder layer. The laser volume energy density ED for printing the 3-dimensional article may be 50 to 150 J/mm³, preferably, 75 to 100 J/mm³, and more preferably, 80 to 90 J/mm³. Moreover, at least one welded powder layer may be applied, and the layer thickness of each welded powder layer can be in a range of 0.01-0.1 mm, and preferably in a range of 0.02-0.07 mm.

Embodiments are directed to a method for 3-dimensional printing an article having a crack-free structure. The method includes supplying successive layers of a Co—Ni—Cr—W—La alloy powder to a powder-based additive manufacturing process, the Co—Ni—Cr—W—La alloy powder having a composition that includes C and La, such that a ratio of C content in wt % to La content in wt % is less than 1.75; and applying a volume energy density of 50 J/mm³ to 150 J/mm³ to the successive layers of the powder.

According to embodiments, the C content of the Co—Ni—Cr—W—La alloy powder composition may be 0.01-0.05 wt %.

In accordance with other embodiments, the Co—Ni—Cr—W—La alloy powder composition may further include 20-24 wt % Ni, 20-24 wt % Cr, 13-16 wt % W, 0.2-0.50 wt % of Si, and >0 wt % Mn. The Co—Ni—Cr—W—La alloy powder composition may further include >0-3.0 wt % Fe, >0-1.25 wt % Mn, and >0-0.015 wt % B.

In embodiments, the additive manufacturing process can include one of selective laser melting (SLM), laser-based powder bed fusion (L-PBF), direct energy deposition (DED)/laser metal deposition (LMD) or the electron beam melting (EBM) processes.

According to still other embodiments, the volume energy density (ED) may be determined from the equation: ED=P/v·h·t, where P is a laser power in W, v is a laser surface scanning speed, h is a hatch spacing and t is a layer thickness of each of the welded powder layers in the powder-based additive manufacturing process.

In accordance with still yet other embodiments, the powder can have a spherical morphology and a particle size distribution of 10-50 μm and a D50 of 25-35 μm.

### DETAILED DESCRIPTION

Prior art Co—Ni—Cr—W—La alloy compositions, whether in solid wrought or powder form, require Carbon (C) and Lanthanum (La) contents, independently of each other, with C ranging from 0.05 wt % to 0.15 wt % and Lanthanum ranging from 0.02 wt % to 0.12 wt %. The typical or nominal content of elements in prior art Co—Ni—Cr—W—La compositions, include contents of C=0.10 wt % and La=0.03 wt %. The typical content of C and La in prior art Co—Ni—Cr—W—La compositions provides a content ratio of C/La that ranges (C/La)ₘₐₓ=7.50 and (C/La)ₘᵢₙ=0.42, while the nominal content of C and La in prior art Co—Ni—Cr—W—La compositions provides a content ratio of (C/La)ₙₒᵣₘ=3.33.

These ranges have been found by the inventors to be unacceptably wide for use in powder-based additive manufacturing, if crack-free or nearly crack-free articles are intended to be produced.

### EXAMPLES

### Comparative Example 1

A prior art Co—Ni—Cr—W—La composition having an actual composition of Ni=22.1 wt %, Cr=22.2 wt %, W=14.6 wt %, Si=0.38 wt %, Fe=0.2 wt %, P<0.01 wt %, S<0.01 wt %, B<0.001 wt %, C=0.09 wt %, La=0.02 wt %, with a balance of Co and unavoidable residual elements and impurities was produced by melting and gas atomization to provide a largely spherical powder having grains generally sized from about 20 to 50 μm and a D50 of 33 μm and a D90 of 49 μm. This material was used in an SLM/L-PBF powder bed additive manufacturing process to produce 3D printed articles using an industry standard L-PBF machine and a volume energy density of 85 J/mm³.

The 3D printed article produced in accordance with Comparative Example 1 exhibited several cracks in the as-built condition and was not further tested for mechanical properties. Table 1 below shows that the prior art Co—Ni—Cr—W—La composition of Comparative Example 1 has a content ratio of C/La of 4.50 for the produced 3D printed article.

As shown in Table 1, notwithstanding that the prior art Co—Ni—Cr—W—La alloy composition is classified as readily weldable by conventional welding techniques, if crack-free or nearly crack-free structures are required or even desired, the chemical composition of powders containing this prior art Co—Ni—Cr—W—La alloy is not suitable for producing 3D printed articles by powder-based additive processing.

TABLE 1
Chemical composition of Comparative Example 1 and Examples
1 and 2 of Co—Ni—Cr—W—La powders

| | COMPARATIVE | | |
|---|---|---|---|
| | EXAMPLE 1 | EXAMPLE 1 | EXAMPLE 2 |
| | Material Form | | |
| | powder | powder | powder |
| | Element [wt %] | | |
| | actual | actual | actual |
| Ni | 22.1 | 21.7 | 22.1 |
| Cr | 22.2 | 21.7 | 22.3 |
| W | 14.6 | 14.1 | 14.4 |
| Fe | 0.2 | 0.2 | 0.2 |
| Co | 40.1 | 41.2 | 39.8 |
| Mn | 0.2 | 0.5 | 0.2 |
| Si | 0.38 | 0.36 | 0.39 |
| C | 0.09 | 0.06 | 0.10 |
| La | 0.02 | 0.04 | 0.08 |
| B | 0.001 | <0.006 | <0.010 |
| P | <0.01 | <0.01 | <0.01 |
| S | <0.01 | <0.01 | <0.01 |
| C / La | 4.50 | 1.50 | 1.25 |
| D10 [μm] | 23 | 21 | 20 |
| D50 [μm] | 33 | 32 | 32 |
| D90 [μm] | 49 | 48 | 49 |

An aspect of the present disclosure and embodiments is to solve the problems exhibited by the prior art Co—Ni—Cr—W—La alloy compositions by identifying specific elements/constituents at specific amounts/contents and their relational inter-dependency in the presently disclosed Co—Ni—Cr—W—La alloy composition, which thereby provide crack-free structures when 3D printed in powder-based additive manufacturing. However, the embodiments are not limited to the expressly disclosed examples, but are understood to include any embodiments suggested in accordance with the disclosure that solve the problems exhibited by the prior art Co—Ni—Cr—W—La compositions without departing from the spirit and scope of the embodiments. Moreover, as demonstrated in Table 1, the content of certain elements in known Co—Ni—Cr—W—La alloy compositions, such as C and La, and a content ratio of C/La in these prior art Co—Ni—Cr—W—La alloy compositions are not effective to avoid cracking in 3D printed articles by powder-based additive manufacturing.

### Example 1

A metal alloy according to a preferred embodiment of the present disclosure was produced by melting and gas atomization to produce a generally spherical powder having grains sized from about 20 to 50 μm, a D50 of 32 μm, and a D90 of 48 μm. The chemical composition of this Example 1 metal alloy was: Ni=21.7 wt %, Cr=21.7 wt %, W=14.1 wt %, Fe=0.2 wt %, Mn=0.5 wt %, Si=0.36 wt %, C=0.06 wt %, La=0.04 wt %, B<0.006 wt %, P<0.01 wt %, S<0.01 wt %, with balance of Co, and unavoidable residual elements and impurities. This material was used in a SLM/L-PBF powder bed additive manufacturing to produce 3D printed articles using an industry standard L-PBF machine and a volume energy density of 85 J/mm³. Table 1 shows that the content ratio of C/La for the Example 1 metal alloy was 1.50 for the produced 3D printed article.

### Example 2

A metal alloy according to another embodiment of the present disclosure was produced by melting and gas atomization to provide a largely spherical powder having grains generally sized from about 20 to 50 μm and a D50 of 32 μm and a D90 of 49 μm. The chemical composition of the metal alloy was as follows: Ni=22.1 wt %, Cr=22.3 wt %, W=14.4 wt %, Fe=0.2 wt %, Mn=0.2 wt %, Si=0.39 wt %, C=0.10 wt %, La=0.08 wt %, B<0.010 wt %, P<0.01 wt %, S<0.01 wt %, with a balance of Co, and unavoidable residual elements and impurities. As shown in Table 1, this Example 2 metal alloy had a content ratio of C/La=1.25 and was used in SLM/L-PBF powder bed additive manufacturing to produce 3D printed articles using an industry standard L-PBF machine with a volume energy density of 85 J/mm³. The produced articles showed no cracks in their as-built structure and samples were subsequently heat treated and tested for mechanical properties at room temperature and elevated temperatures.

3D printed samples produced from the material in accordance with Example 2 were heat treated at 1177° C. for 45 minutes and subsequently rapidly cooled in air. The heat-treated material was subsequently machined into a test specimen having a diameter in the gauge length of 6.41 mm, and was then subjected to testing to determine the tensile properties of the material according to ASTM E8-16a at 20° C., 537° C. and 649° C. As shown in Table 2 below, the material produced in accordance with Examiner 2 exhibited excellent Yield Strength and Ultimate Tensile Strength as compared to the data of wrought material, such as laid down in AMS 5608G. Also, the ductility values (elongation at rupture) of the material exhibit elevated levels, which is indicative of a good build and the resulting crack-free structure of this material.

TABLE 2

| | | | | Ultimate | |
|---|---|---|---|---|---|
| Test | | | 0.2% Yield | Tensile | Elongation |
| Temperature | Direction of Test | Test Direction | Strength | Strength | at Rupture |
| [° C.] | Sample Axis | Abbreviated | [MPa] | [MPa] | [%] |
| 20 | normal to build plate | Z | 587 | 986 | 45.5 |
| 20 | parallel to build plate | Y | 619 | 1095 | 33.0 |
| 537 | normal to build plate | Z | 447 | 832 | 50.0 |
| 537 | parallel to build plate | Y | 470 | 866 | 37.6 |
| 649 | normal to build plate | Z | 432 | 807 | 33.9 |
| 649 | parallel to build plate | Y | 446 | 816 | 25.6 |

Additionally, the anisotropy of the material described in Examples 1 and 2, which is the difference between strength and the ductility of samples that were built with their main axis parallel or normal to the L-PBF machine build plate, Y and Z, is relatively low, which is beneficial.

Since the Co—Ni—Cr—W—La alloy described in Examples 1 and 2 is intended for use at high temperatures, creep testing in the form of so-called stress-rupture testing was performed in accordance with the requirements of AMS 5608G for a plate of the Co—Ni—Cr—W—La materials, which typically calls for a minimum life of 23 hours under a stress of 76 MPa at a temperature of 927° C. for the commercial material. Stress was increased by 13.8 MPa every 8-10 hours.

The results of stress-rupture testing are shown in Table 3. As shown in Table 3, the requirement for commercial wrought material is exceeded for the alloy composition in accordance with Example 2, which is attributed to the sound and crack-free structure of the material produced in accordance with Example 2.

TABLE 3

| | | Initial | Final Average | Average | Average Elongation |
|---|---|---|---|---|---|
| | Abbreviated | Stress for | Stress at Rupture | Rupture Time | at Rupture |
| Direction of Test | Test | first 23 h | (5 Samples) | (5 Samples) | (5 Samples) |
| Sample Axis | Direction | [MPa] | [MPa] | [h] | [%] |
| normal to build | Z | 76 | 99 | 44.2 | 30.3 |
| plate | | | | | |
| parallel to build | Y | 76 | 126 | 47.5 | 40.0 |
| plate | | | | | |

The present disclosure is not limited to the above-described embodiments and examples. For example, the disclosed Co—Ni—Cr—W— La alloy is not only suitable for the SLM/L-PBF process, but also for the powder-nozzle additive manufacturing processes, also referred to as laser metal deposition (LMD) or direct energy deposition (DED) as well as the electron beam melting (EBM) process, with the described advantages.

Further, at least because the invention is disclosed herein in a manner that enables one to make and use it, by virtue of the disclosure of particular exemplary embodiments, such as for simplicity or efficiency, for example, the invention can be practiced in the absence of any additional element or additional structure that is not specifically disclosed herein.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An alloy powder for powder-based additive manufacturing, comprising:
a powder comprising:
20-24 wt % of Ni;
20-24 wt % of Cr;
13-16 wt % of W;
0.2-0.50 wt % of Si;
>0 wt % of Mn;
>0 wt % of C;
>0 wt % of La; and
a balance of Co,
wherein a ratio in a content of C to La in the powder is 0.1 to 1.75.

2. The alloy powder according to claim 1, wherein the C content is 0.01 to 0.05 wt %.

3. The alloy powder according to claim 1, wherein the powder has a particle size distribution of 10-120 μm.

4. The alloy powder according to claim 1, wherein the powder has a spherical morphology and a particle size distribution of 10-50 μm and a D50 of 25-35 μm.

5. The alloy powder according to claim 1, wherein the powder further comprises:
>0-3 wt % of Fe;
>0-1.25 wt % of Mn; and
>0-0.015 wt % of B.

6. A method for additive manufacturing a 3-dimensional article comprising:
subjecting the alloy powder according to claim 1 to a powder-based additive manufacturing process having a laser volume energy density calculated by:
$${E}_{D} = P / v . h . t ,$$
wherein P is laser power, v is laser surface scanning speed, h is hatch spacing, and t is a layer thickness for each welded powder layer, and
wherein the laser volume energy density E_{D} for printing the 3-dimensional article is 50 to 150 J/mm³.

7. The method according to claim 6, wherein the laser volume energy density E_{D} for printing the 3-dimensional article is 75 to 100 J/mm³.

8. The method according to claim 6, wherein the laser volume energy density E_{D} for printing the 3-dimensional article is 80 to 90 J/mm³.

9. The method according to claim 6, wherein at least one welded powder layer is applied, and the layer thickness of each welded powder layer is in a range of 0.01-0.1 mm.

10. The method according to claim 6, wherein the layer thickness of each welded powder layer is in a range of 0.02-0.07 mm.

11. A method for 3-dimensional printing an article having a crack-free structure, the method comprising:
supplying successive layers of a Co—Ni—Cr—W—La alloy powder to a powder-based additive manufacturing process, the Co—Ni—Cr—W—La alloy powder having a composition that includes C and La, such that a ratio of C content in wt % to La content in wt % is less than 1.75; and
applying a volume energy density of 50 J/mm³ to 150 J/mm³ to the successive layers of the powder.

12. The method according to claim 11, wherein the C content of the Co—Ni—Cr—W—La alloy powder composition is 0.01-0.05 wt %.

13. The method according to claim 11, wherein the Co—Ni—Cr—W—La alloy powder composition further includes 20-24 wt % Ni, 20-24 wt % Cr, 13-16 wt % W, 0.2-0.50 wt % of Si; and >0 wt % Mn.

14. The method according to claim 13, wherein the Co—Ni—Cr—W—La alloy powder composition further includes >0-3.0 wt % Fe, >0-1.25 wt % Mn, and >0-0.015 wt % B.

15. The method according to claim 11, wherein the additive manufacturing process comprises one of selective laser melting (SLM), laser-based powder bed fusion (L-PBF), direct energy deposition (DED)/laser metal deposition (LMD) or the electron beam melting (EBM) processes.

16. The method according to claim 11, wherein the volume energy density (E_{D}) is determined from the equation:
$${E}_{D} = P / v \cdot h \cdot t ,$$
where P is a laser power in W, v is a laser surface scanning speed, h is a hatch spacing and t is a layer thickness of each of the welded powder layers in the powder-based additive manufacturing process.

17. The method according to claim 11, wherein the powder has a spherical morphology and a particle size distribution of 10-50 μm and a D50 of 25-35 μm.
